(19) United States
(12) Patent Application Publication
(10) Pub. No.: US 2017/0033828 A1
(43) Pub. Date: Feb. 2, 2017

(54) DEVICE WITH SHARED ANTENNA FOR TRANSCEIVER AND RFID TAG

(71) Applicant: Motorola Mobility LLC, Chicago, IL (US)

(72) Inventors: Hong Zhao, Naperville, IL (US); Timothy P. Froehling, Palatine, IL (US)

(21) Appl. No.: 14/810,862

(22) Filed: Jul. 28, 2015

(51) Int. Cl. H04B 1/401; G06K 7/10

(52) U.S. Cl. CPC H04B 1/401; G06K 7/10316

(57) ABSTRACT

A device includes an antenna, a transceiver, a radio frequency identification (RFID) tag, and a zero bias switch coupled to the antenna. The zero bias switch has a first path that couples the RFID tag to the antenna and isolates the RFID tag from the transceiver when the zero bias switch is in an unpowered state. A method includes selectively coupling an antenna to one of a radio frequency identification (RFID) tag or an RFID interrogator using a zero bias switch, wherein the zero bias switch has a first path that couples the RFID tag to the antenna and isolates the RFID tag from the RFID interrogator when the zero bias switch is in an unpowered state.

### BACKGROUND

Field of the Disclosure

The disclosed subject matter relates generally to mobile computing systems and, more particularly, to a device with a shared antenna for a transceiver and an RFID tag.

Description of the Related Art

Radio frequency identification (RFID) technology employs magnetic signals to transfer data. RFID tags store digital data which may be read or written by an RFID interrogator. The RFID interrogator transmits a modulated radio frequency (RF) interrogation signal to the tag. The RFID tag generally includes an antenna and an integrated circuit chip that stores the identification data. In a passive RFID system, the RFID tags do not require their own power sources. Rather, in a passive RFID system, the integrated circuit chip in the RFID tag receives power from the interrogator signal and outputs its identification data by modulating a backscattered signal.

The range of a passive RFID system depends on the frequency range over which the system operates. Low frequency (LF) systems typically operate in the kHz range, high frequency systems (HF) operate in the low MHz range, and ultra-high frequency (UHF) systems operate in the high MHz range or low GHz range.

In some devices, RFID tags may be used to facilitate data exchanges, such as payment transactions between a merchant and a customer, data sharing (e.g., contact information or photographs) between two devices, or advertisement data exchange. In such applications, a device, such as a mobile phone, may include both an RFID tag and an RFID interrogator. In a LF or HF system, the power difference between the tag and the interrogator is not significant, so they may be integrated into a single chipset. However, for UHF systems, the power mismatch is significant, making it difficult to share an antenna and adequately isolate the passive tag from the active interrogator.

The present disclosure is directed to various methods and devices that may solve or at least reduce some of the problems identified above.

### BRIEF DESCRIPTION OF THE DRAWINGS

The present disclosure may be better understood, and its numerous features and advantages made apparent to those skilled in the art by referencing the accompanying drawings.

FIGS. 1-2 are simplified block diagrams of a device having a shared antenna for an RFID tag and an RFID interrogator, according to some embodiments disclosed herein; and

FIG. 3 is a simplified block diagrams of an alternative embodiment of the device that includes a diversity switch for supporting multi-band telephony communication in addition to RFID services, according to some embodiments disclosed herein.

The use of the same reference symbols in different drawings indicates similar or identical items.

### DETAILED DESCRIPTION OF EMBODIMENT(S)

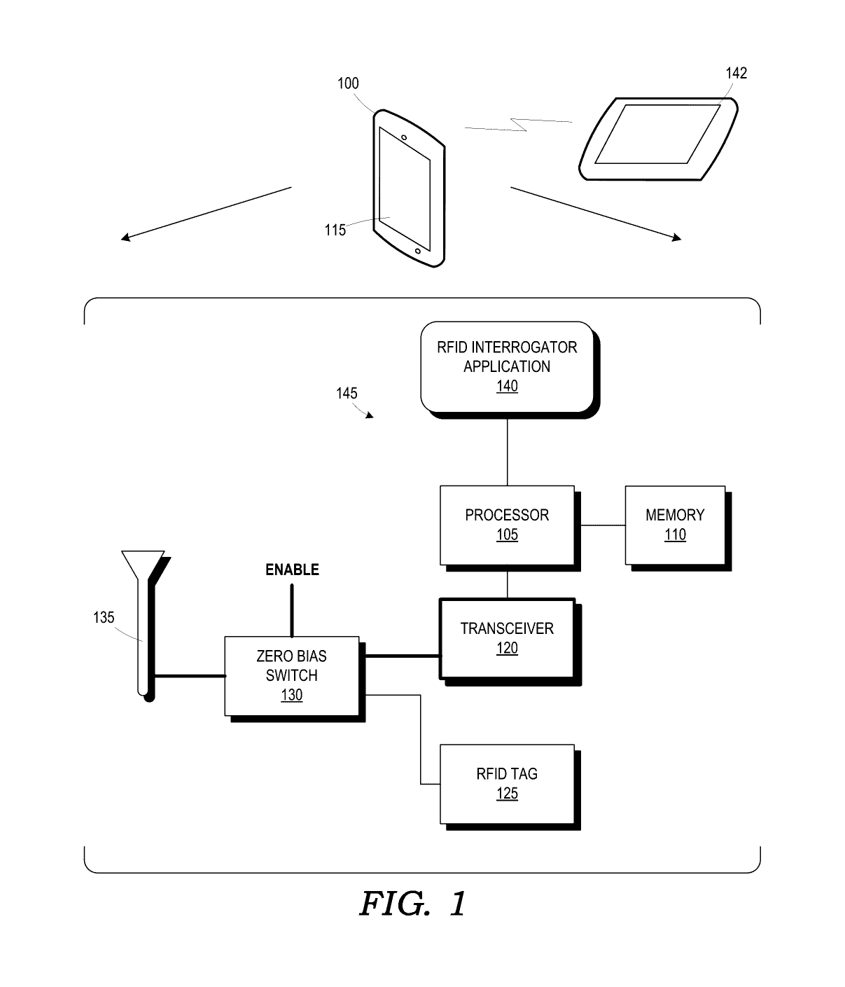

FIGS. 1-3 illustrate example devices having shared antennas for RFID tags and RFID interrogators that may operate in an ultrahigh frequency (UHF) range. In one embodiment, UFH frequencies generally falls in the range of 860-930 MHz. In general, each country regulates the various spectrum ranges, including the UHF range. A zero bias switch connects the RFID tag and RFID interrogator to a common antenna path. The zero bias switch has a default path to the RFID tag when it is in an unpowered state. As a result, the passive RFID tag may be accessed when the zero bias switch is powered down, and the zero-bias switch isolates the RFID tag from the RFID interrogator during operation. The tag and interrogator may be integrated into a mobile device, such as a mobile telephony device, which may also share the antenna.

FIG. 1 is a simplistic block diagram of one illustrative example of a device 100 disclosed herein that includes, among other things, a processor 105, a memory 110, a display 115, a transceiver 120, a radio frequency identification (RFID) tag 125, a zero bias switch 130, and an antenna 135. The memory 110 may be a volatile memory (e.g., DRAM, SRAM) or a non-volatile memory (e.g., ROM, flash memory, hard disk, etc.). The transceiver 120 transmits and receiving signals via the antenna 135 to implement RFID reading functionality. The transceiver 120 may include one or more radios for communicating according to different radio access technologies and over multiple frequency bands.

In various embodiments, the device 100 may be embodied in a handheld or wearable device, such as a laptop computer, a handheld computer, a tablet computer, a mobile device, a telephones, a personal data assistants, a music player, a game device, a wearable computing device, and the like. To the extent certain example aspects of the device 100 are not described herein, such example aspects may or may not be included in various embodiments without limiting the spirit and scope of the embodiments of the present application as would be understood by one of skill in the art.

In the device 100, the processor 105 may execute instructions stored in the memory 110 and store information in the memory 110, such as the results of the executed instructions. Some embodiments of the processor 105 and the memory 110 may be configured to implement an RFID interrogator application 140. For example, the processor 105 may execute the RFID interrogator application 140 to query nearby RFID tags (not shown) to extract information such as identification data, security data, program instructions, etc., to facilitate data exchanges (e.g., commercial transactions, data sharing, advertisement data) between a user of the device 100 and another party via a remote device 142 (e.g., a mobile telephone, a payment device, an advertising device, etc.).

The processor 105, memory 110, transceiver 120, and RFID interrogator application 140 collectively define an RFID interrogator 145. The particular software and signaling techniques for implementing the RFID interrogator 145 are known to those of ordinary skill in the art, so they are not described in detail herein. In general, the RFID tag 125 is a passive device that does not require its own power source to function. The RFID tag 125 includes non-volatile memory or logic that stores data, such as identification data, security data, or instruction data, and transmits the stored data using a backscattering modulation technique responsive to an RFID query from a remote RFID tag interrogator (not shown). The particular circuit elements for constructing an RFID tag are known to those of ordinary skill in the art, so they are not described in detail herein.

The RFID interrogator 145 is an active device that requires power to operate. The zero bias switch 130 has a default path from the RFID tag 125 to the antenna 135. The zero bias switch 130 may be implemented using a microelectromechanical systems (MEMS) device, a relay, etc., that provides a deterministic default circuit path when the zero bias switch 130 is in an unpowered state. When the enable signal is asserted (e.g., when the device 100 is in a powered state), the zero bias switch 130 provides a path coupling the RFID interrogator 145 to the antenna 135. As illustrated in FIG. 1, the enable signal for the zero bias switch 130 is asserted, which connects the RFID interrogator 145 to the antenna 135 (as indicated by bold lines). In some embodiments, the processor 105 may selectively assert the enable signal to facilitate the operation of either the RFID interrogator 145 or the RFID tag 125 when the device 100 is in a powered state.

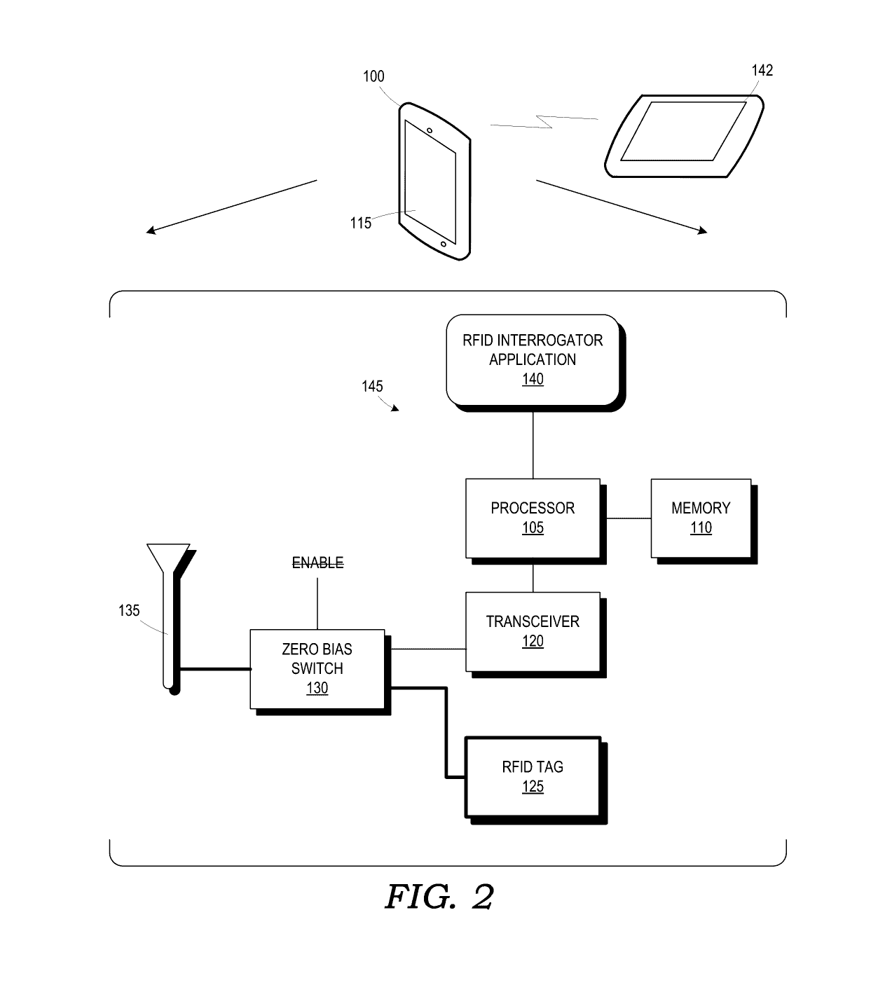

FIG. 2 illustrates the device 100 during a time period that the device 100 is in an unpowered state or the enable signal is deasserted by the processor 105. When the zero bias switch 130 is not enabled (no power to the switch 130), it isolates the RFID interrogator 145 from the antenna 135 and connects the RFID tag 125 to the antenna 135.

During a data exchange, the enable signal may be selectively enabled or disabled to allow either the RFID tag 125 or the RFID interrogator 145 to operate. For example, an exchange may be initiated by the device 100 by reading data from a remote RFID tag (not shown) to identify the remote device 142. This query may be implemented by asserting the enable signal and employing the RFID interrogator 145. Subsequently, the enable signal may be deasserted for a predetermined time period to allow the remote device 142 to access the RFID tag 125 to identify the device 100.

In some embodiments, the processor 105, memory 110, and transceiver 120 may also implement telephony services, such as cellular telephony services. The transceiver 120 may operate using multiple frequency bands. The zero bias switch 130 may be integrated with a single pole multiple throw (SPxT) diversity switch that supports multiple frequency bands. In such an embodiment, the enable signal may also select the desired frequency band. Although one antenna 135 is illustrated in the device 100, in some embodiments, multiple antennas may be present. If additional antennas are present, they may be employed by the transceiver 120 in a diversity mode, where the antenna 135 and one or more additional antennas may be coupled to the transceiver 120 when the device 100 is operating.

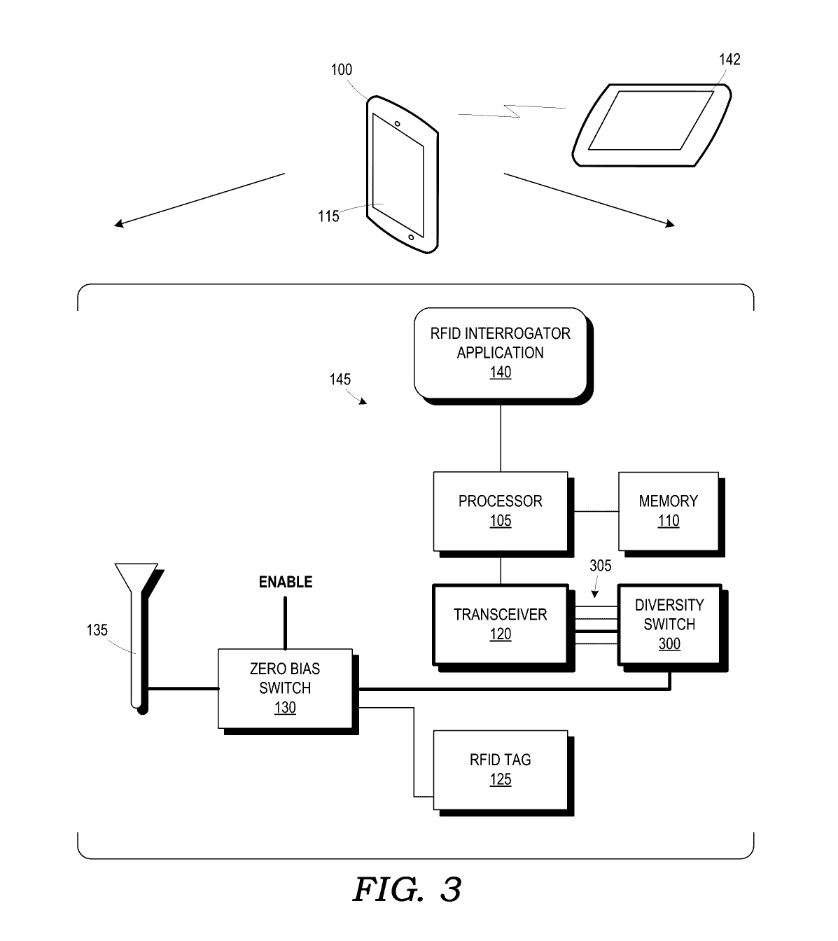

FIG. 3 is a simplistic block diagram of an alternative embodiment of the device 100, where a separate diversity switch 300 is provided between the transceiver 120 and the zero bias switch 130 to support multiple frequency bands using multiple signal lines 305. The processor 105 or the transceiver 120 configures the diversity switch 300 to select the particular signal line for the desired band employed by the transceiver 120. One of the signal lines 305 may be dedicated to the RFID interrogator 145. The processor 105 controls the zero bias switch 130 to select between the RFID tag 125 and the diversity switch 300 to support selectively RFID or telephone operation. When the device 100 is powered down, the default path of the zero bias switch 130 connects the RFID tag 125 to the antenna 135 and isolates the RFID tag 125 from the diversity switch 300.

In some embodiments, certain aspects of the techniques described above may be implemented by one or more processors of a processing system executing software. The techniques may be implemented by executing software on a computing device, such as the processor 105 of FIGS. 1-3, however, such methods are not abstract in that they improve the operation of the device 100 and the user's experience when operating the device 100. Prior to execution, the software instructions may be transferred from a non-transitory computer readable storage medium to a memory, such as the memory 110 of FIGS. 1-3.

The software may include one or more sets of executable instructions stored or otherwise tangibly embodied on a non-transitory computer readable storage medium. The software can include the instructions and certain data that, when executed by one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

A device includes an antenna, a transceiver, a radio frequency identification (RFID) tag, and a zero bias switch coupled to the antenna. The zero bias switch has a first path that couples the RFID tag to the antenna and isolates the RFID tag from the transceiver when the zero bias switch is in an unpowered state.

A device includes an antenna, a radio frequency identification (RFID) tag, an RFID interrogator, and a zero bias switch coupled to the antenna. The zero bias switch has a first path that couples the RFID tag to the antenna and isolates the RFID tag from the RFID interrogator when the device is in an unpowered state.

A method includes selectively coupling an antenna to one of a radio frequency identification (RFID) tag or an RFID interrogator using a zero bias switch, wherein the zero bias switch has a first path that couples the RFID tag to the antenna and isolates the RFID tag from the RFID interrogator when the zero bias switch is in an unpowered state.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

1. A device, comprising:
an antenna;
a transceiver;
a radio frequency identification (RFID) tag; and
a zero bias switch coupled to the antenna, wherein the zero bias switch has a first path that couples the RFID tag to the antenna and isolates the RFID tag from the transceiver when the zero bias switch is in an unpowered state.

2. The device of claim 1, wherein the zero bias switch has a second path that couples the transceiver to the antenna when the device is in a powered state.

3. The device of claim 1, wherein the zero bias switch has a second path that couples the transceiver to the antenna when the device is in a powered state and an enable signal for the zero bias switch is asserted.

4. The device of claim 3, wherein the zero bias switch selects the first path to couple the RFID tag to the antenna when the enable signal is deasserted.

5. The device of claim 1, further comprising a diversity switch connected between the transceiver and the zero bias switch.

6. The device of claim 5, wherein the transceiver is capable of supporting communication using a plurality of frequency bands over a plurality of signal lines, and the diversity switch is configurable to selectively couple a selected one of the signal lines for a selected one of the frequency bands to the zero bias switch.

7. The device of claim 1, further comprising a processor coupled to the transceiver, whereon the processor is to execute an RFID interrogator application.

8. The device of claim 1, wherein the transceiver comprises a telephony transceiver.

9. A device, comprising:
an antenna;
a radio frequency identification (RFID) tag;
an RFID interrogator; and
a zero bias switch coupled to the antenna, wherein the zero bias switch has a first path that couples the RFID tag to the antenna and isolates the RFID tag from the RFID interrogator when the zero bias switch is in an unpowered state.

10. The device of claim 9, wherein the zero bias switch has a second path that couples the RFID interrogator to the antenna when the device is in a powered state.

11. The device of claim 9, wherein the zero bias switch has a second path that couples the RFID interrogator to the antenna when the device is in a powered state and an enable signal for the zero bias switch is asserted.

12. The device of claim 11, wherein the zero bias switch selects the first path to couple the RFID tag to the antenna when the enable signal is deasserted.

13. The device of claim 9, wherein the RFID interrogator comprises a processor and a memory for storing instructions, that when executed by the processor, execute an RFID interrogator application.

14. A method, comprising:
selectively coupling an antenna to one of a radio frequency identification (RFID) tag or an RFID interrogator using a zero bias switch, wherein the zero bias switch has a first path that couples the RFID tag to the antenna and isolates the RFID tag from the RFID interrogator when the zero bias switch is in an unpowered state.

15. The method of claim 14, wherein the zero bias switch has a second path that couples the RFID interrogator to the antenna when an enable signal for the zero bias switch is asserted, and the method further comprises asserting the enable signal.

16. The method of claim 15, further comprising deasserting the enable signal to couple the RFID tag to the antenna.

17. The method of claim 14, wherein the zero bias switch has a second path that couples the RFID interrogator to the antenna when an enable signal for the zero bias switch is asserted, and the method further comprises:
asserting the enable signal;
reading information from a remote RFID tag using the RFID interrogator; and
deasserting the enable signal to allow information to be read from the RFID tag.

18. The method of claim 17, wherein deasserting the enable signal comprises deasserting the enable signal for a predetermined time period.
